(19) United States
(12) Patent Application Publication
(10) Pub. No.: US 2017/0242315 A1
(43) Pub. Date: Aug. 24, 2017

(54) ELECTRONICALLY DIMMING WINDOW WITH IMPROVED PERFORMANCE

(71) Applicant: Gentex Corporation, Zeeland, MI (US)

(72) Inventors: Kevin L. Ash, Grand Rapids, MI (US); Michael T. Stephenson, Holland, MI (US); Carl N. Wassink, Holland, MI (US)

(73) Assignee: Gentex Corporation

(21) Appl. No.: 15/437,838

(22) Filed: Feb. 21, 2017

Related U.S. Application Data
(60) Provisional application No. 62/408,448, filed on Oct. 14, 2016.
(60) Provisional application No. 62/298,404, filed on Feb. 22, 2016.

(51) Int. Cl. G02F 1/163; B60J 3/04

(52) U.S. Cl. CPC G02F 1/163; B60J 3/04

(57) ABSTRACT

A control system for variable transmittance windows is disclosed. The system comprises at least one electro-optic element, a local control circuit, and a feedback circuit. The local control circuit is in communication with the electro-optic element via a conductive supply. The feedback circuit is in communication with the conductive supply and configured to communicate a feedback signal to the local control circuit. The local control circuit is configured to receive the feedback signal and adjust an output voltage transmitted to the conductive supply in response to the feedback signal.

### CROSS-REFERENCE TO RELATED APPLICATIONS

This application claims benefit to U.S. Provisional Application No. 62/408,448, filed on Oct. 14, 2016, entitled “MONITORED VOLTAGE OF EDW FOR IMPROVED PERFORMANCE,” and U.S. Provisional Application No. 62/298,404, filed on Feb. 22, 2016, entitled “MONITORED VOLTAGE OF EDW FOR IMPROVED PERFORMANCE,” the disclosures of which are hereby incorporated herein by reference in their entireties.

### BACKGROUND OF THE INVENTION

The present invention generally relates to variable transmission windows. More specifically, the present invention relates to control systems for controlling the transmission of variable transmission windows.

Variable transmittance light filters, such as electrochromic light filters, have been proposed for use in architectural windows, skylights, and in windows, sunroofs, and rearview mirrors for automobiles. Such variable transmittance light filters reduce the transmittance of direct or reflected sunlight during daytime through the window, while not reducing such transmittance during nighttime. Not only do such light filters reduce bothersome glare and ambient brightness, but they also reduce fading and generated heat caused by the transmission of sunlight through the window.

Variable transmission windows have not been widely accepted commercially for several reasons. First, they tend to be very expensive due to the cost of materials required for their construction, and their complex construction can make mass-production difficult. Additionally, electrochromic windows tend to have a lower life expectancy than conventional windows due to degradation of the electrochromic materials used in the windows. The combination of added cost and lower life expectancy has deterred many architects, designers, and builders from using electrochromic windows.

Variable transmission windows have also not been widely accepted commercially in vehicles designed for the transportation of passengers, such as, for example, busses, airplanes, trains, ships, and automobiles. The inventors have recognized that providing for the use of variable transmission windows in these types of vehicles provides challenges in addition to those already noted above. These challenges can include, but are not limited to, providing effective, coordinated, individual and central control of multiple variable transmission windows, providing multiple modes of operation responsive to individual or collective passenger needs, providing the ability to quickly change window transmittance states, minimizing system power consumption, protecting against environmental factors such as moisture and power surges, protecting windows from excessive heat and physical external loads, and providing user interfaces allowing relatively unsophisticated users to understand and control the windows. The inventors have also recognized that manufacturing challenges can prove a barrier to providing system features needed to address the above-identified needs.

### SUMMARY OF THE INVENTION

According to one aspect of the present invention, a control system for variable transmittance windows is disclosed. The system comprises at least one electro-optic element, a local control circuit, and a feedback circuit. The local control circuit is in communication with the electro-optic element via a conductive supply and is configured to control an output voltage. The feedback circuit is in communication with the conductive supply. The feedback circuit is configured to measure a supplied voltage received at the conductive supply and communicate a feedback signal to the local control circuit. The local control circuit is configured to receive the feedback signal and identify the supplied voltage based on the feedback signal. Based on the feedback signal, the local control circuit is configured to compare the supplied voltage to an optimum voltage level and adjust the output voltage in response to the comparison.

According to another aspect of the present invention, a method for controlling a transmission level of a variable transmission window is disclosed. The method comprises measuring a supplied voltage at a conductive supply of the variable transmission window and communicating the supplied voltage to a controller as a feedback signal. The method further comprises receiving the feedback signal at the controller, identifying a supplied voltage at the conductive supply based on the feedback signal, and comparing the supplied voltage to an optimum voltage level. In response to the comparison, the method further comprises adjusting an output voltage. The output voltage is adjusted thereby correcting for a loss in the supplied voltage at the conductive supply.

According to yet another aspect of the present invention, a control system for variable transmittance windows is disclosed. The system comprises at least one electro-optic element, a local control circuit, and a feedback circuit. The local control circuit is in communication with the electro-optic element via a conductive supply. The feedback circuit is in communication with the conductive supply and configured to communicate a feedback signal to the local control circuit. The local control circuit is configured to receive the feedback signal and adjust an output voltage transmitted to the conductive supply in response to the feedback signal.

The above aspects may be implemented separately or in various combinations. Although described as different aspects or in different embodiments, the characteristics thereof are not necessarily mutually exclusive of one another and thus may be used together.

These and other features, advantages and objects of the present invention will be further understood and appreciated by those skilled in the art by reference to the following specification, claims and appended drawings.

### BRIEF DESCRIPTION OF THE DRAWINGS

In the drawings:

FIG. 1 is a general illustration of multi-passenger vehicles incorporating variable transmission windows, according to one embodiment of the present invention;

FIG. 2 is a block diagram generally illustrating a system for controlling variable transmission windows, according to the present invention;

FIG. 3 is a detailed block diagram generally illustrating a system for controlling variable transmission windows, according to the present invention;

FIG. 4 is a front view generally illustrating a variable transmission window and system for controlling the variable transmission window according to one embodiment of the present invention;

FIG. 5 is a perspective view of one panel of an electrochromic element employed in the variable transmission window illustrated in FIG. 4;

FIG. 6 is a partial cross-sectional view taken through line VI-VI of the variable transmission window and supporting structure illustrated in FIG. 4;

FIG. 7 is graph of a current limit versus a transition time in seconds for a variable transmittance window control system with a sense electrode and a variable transmittance window control system without a sense electrode; and

FIG. 8 is graph demonstrating a performance comparison of variable transmission window control systems comprising voltage sensing of supplied voltage and conventional control systems in accordance with the disclosure.

### DETAILED DESCRIPTION OF THE PREFERRED EMBODIMENTS

Reference will now be made in detail to the present preferred embodiments of the invention, examples of which are illustrated in the accompanying drawings. Wherever possible, the same reference numerals will be used throughout the drawings to refer to the same or like parts.

For purposes of description herein, the terms “upper,” “lower,” “right,” “left,” “rear,” “front,” “vertical,” “horizontal,” “top,” “bottom,” and derivatives thereof shall relate to the invention as shown in the drawings. However, it is to be understood that the invention may assume various alternative orientations, except where expressly specified to the contrary. It is also to be understood that the specific device illustrated in the attached drawings and described in the following specification is simply an exemplary embodiment of the inventive concepts defined in the appended claims. Hence, specific dimensions, proportions, and other physical characteristics relating to the embodiment disclosed herein are not to be considered as limiting, unless the claims expressly state otherwise.

The present invention pertains to a novel electrical control system for controlling the transmission of a plurality of variable transmission windows. Examples of variable transmission windows include windows that are able to change their transmissivity based on electrical signals applied to the window, such as the windows generally described in commonly assigned U.S. Pat. No. 6,407,847 entitled “ELECTROCHROMIC MEDIUM HAVING A COLOR STABILITY”, U.S. Pat. No. 6,239,898 entitled “ELECTROCHROMIC STRUCTURES,” U.S. Pat. No. 6,597,489 entitled “ELECTRODE DESIGN FOR ELECTROCHROMIC DEVICES,” and U.S. Pat. No. 5,805,330 entitled “ELECTRO-OPTIC WINDOW INCORPORATING A DISCRETE PHOTOVOLTAIC DEVICE,” the entire disclosures of each of which are incorporated herein by reference. Examples of electrochromic devices that may be used in windows are described in U.S. Pat. No. 6,433,914 entitled “COLOR-STABILIZED ELECTROCHROMIC DEVICES,” U.S. Pat. No. 6,137,620 entitled “ELECTROCHROMIC MEDIA WITH CONCENTRATION-ENHANCED STABILITY, PROCESS FOR THE PREPARATION THEREOF AND USE IN ELECTROCHROMIC DEVICES,” U.S. Pat. No. 5,940,201 entitled “ELECTROCHROMIC MIRROR WITH TWO THIN GLASS ELEMENTS AND A GELLED ELECTROCHROMIC MEDIUM,” and U.S. Patent Application Publication No. 2006/0056003 entitled “VEHICULAR REARVIEW MIRROR ELEMENTS AND ASSEMBLIES INCORPORATING THESE ELEMENTS,” the entire disclosures of each of which are incorporated herein by reference. Other examples of variable transmission windows and systems for controlling them are disclosed in commonly assigned U.S. Pat. No. 7,085,609, entitled “VARIABLE TRANSMISSION WINDOW CONSTRUCTIONS,” U.S. Pat. No. 6,567,708 entitled “SYSTEM TO INTERCONNECT, LINK, AND CONTROL VARIABLE TRANSMISSION WINDOWS AND VARIABLE TRANSMISSION WINDOW CONSTRUCTIONS,” the entire disclosures of each of which are incorporated herein by reference.

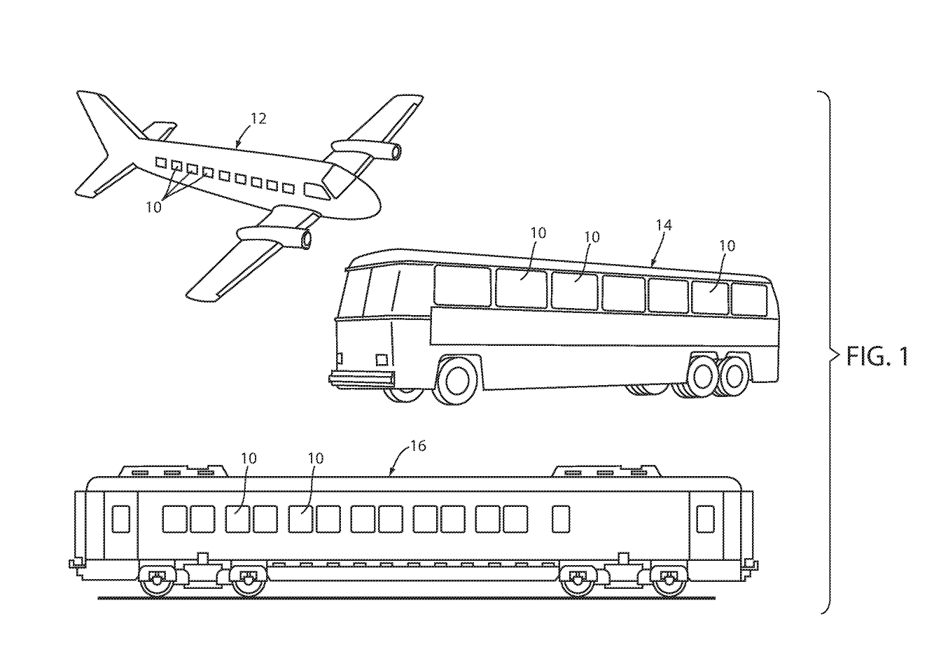

FIG. 1 is a graphical representation of multi-passenger vehicles employing variable transmittance windows 10. Mass transit multi-passenger vehicles employing variable transmittance windows 10 include, for example, aircraft 12, buses 14, and trains 16. It should be appreciated that any form of vehicle including other multi-passenger vehicles may employ variable transmittance windows 10. The multi-passenger vehicles generally illustrated in FIG. 1 also include window control systems (not shown) for controlling variable transmittance windows 10.

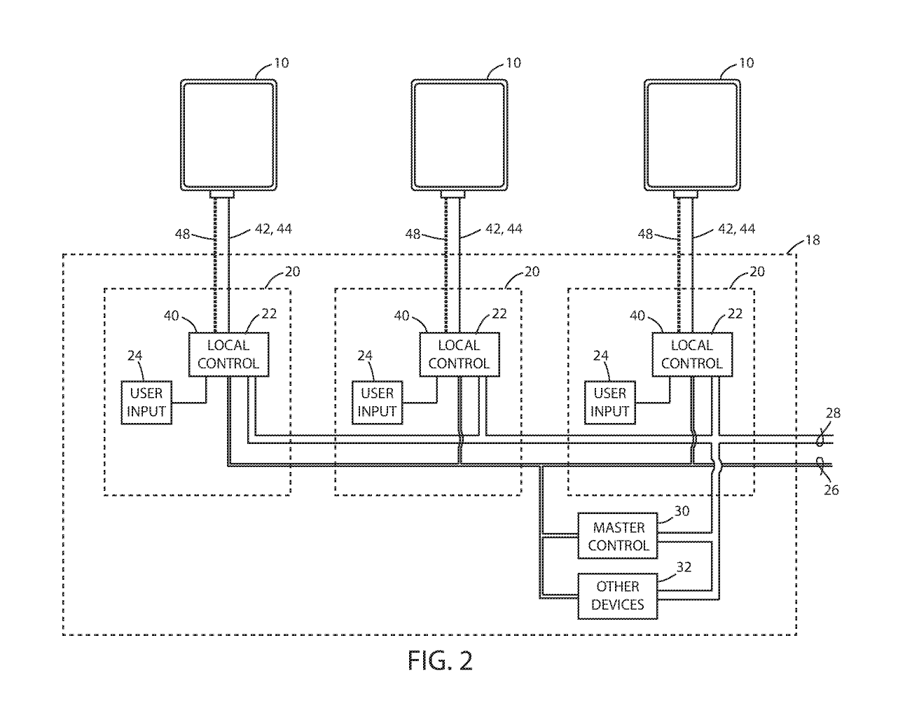

FIG. 2 generally illustrates a plurality of variable transmittance windows 10 that may be employed in vehicles. The windows may be in communication with a window control system 18 electrically coupled to the variable transmittance windows 10 for controlling the transmittance state of the variable transmittance windows 10. Window control system 18 includes a window control unit 20 coupled to each of the variable transmittance windows 10 for controlling the transmittance of each of the variable transmittance windows 10. Each window control unit 20 includes local control circuitry 22 for controlling the transmittance state of an associated variable transmittance window 10. Each window control unit 20 is also shown having a user input mechanism 24 coupled to local control circuitry 22 for providing a user input to local control circuitry 22 to change the transmittance state of the associated variable transmittance window 10. Each window control unit 20 is also shown coupled to power and ground lines 26 for providing power to local control circuitry 22, user input mechanism 24, and variable transmittance window 10. As shown, power is provided to variable transmittance window 10 via local control circuitry 22 from the power and ground lines 26.

Each window control unit 20 is also shown coupled to a window control system bus 28. Other devices also coupled to the window control system bus 28 include master control circuitry 30 and other electronic devices 32. Master control circuitry 30 is configured to monitor signals provided on the window control system bus 28 by each of window control units 20 and to provide control signals on the bus to each of window control units 20. Master control circuitry 30 includes processing circuitry, including logic, memory, and bus interface circuitry, to permit master control circuitry 30 to generate, send, receive, and decode signals on the window control system bus 28. Local control circuitry 22, included in each of window control units 20, is configured to receive a desired window transmittance state from user input mechanism 24, and provide electrical signals to variable the transmittance window 10 to change the transmittance state of variable transmittance window 10 to the state requested by the user via user input mechanism 24.

Local control circuitry 22 is also configured to monitor various characteristics of variable transmittance window 10, including the power consumed by variable transmittance window 10 and the transmittance state of variable transmittance window 10. In some embodiments, the local control circuitry 22 may comprise a memory configured to store one or more voltage levels to identify a desired or optimum voltage level to identify the delivered voltage or current supplied to the electrochromic element 46 or the electrochromic supplies 42 and 44. The desired or optimum voltage level may be predetermined based on the particular hardware or components for the local control circuitry and other components of the window control system 18. Local control circuitry 22 also includes circuitry for receiving signals from, and sending signals to, the window control system bus 28.

Master control circuitry 30 is configured to issue override signals to window control units 20 via the window control system bus 28. These override signals have the effect of directing the local control circuitry 22 of each of window control units 20 to change the transmittance state of variable transmittance windows 10 to the state selected by the override signal sent by master control circuitry 30. Override signals issued on the window control system bus 28 by master control circuitry 30 may include signals to cause all variable transmittance windows to darken, lighten, go to the darkest state, go to the lightest state, or go to a predetermined intermediate transmittance state. Master control circuitry 30 may be configured to direct all window control units 20 to alter their states at the same time, or may direct window control units 20 to alter the transmittance state of each window one at a time, or in groups, in order to minimize system power loading.

Master control circuitry 30 may also be configured to direct window control units 20 to alter the transmittance state of all windows simultaneously, but in incremental steps. For example, in one mode, master control circuitry 30 directs window control units 20 to change the transmittance state of the variable transmittance windows 10 to the darkest transmittance state simultaneously in 10 percent increments. Master control circuitry 30 and window control units 20 may be configured to maintain an override transmittance state for a predetermined period of time determined by master control circuitry 30, after which time individual users may change the transmittance state of individual windows via user input mechanism 24. It should be appreciated that various embodiments of the master control circuitry 30 may be configured to change a window or multiple windows to intermediate transmittance states between the highest and lowest transmittance states.

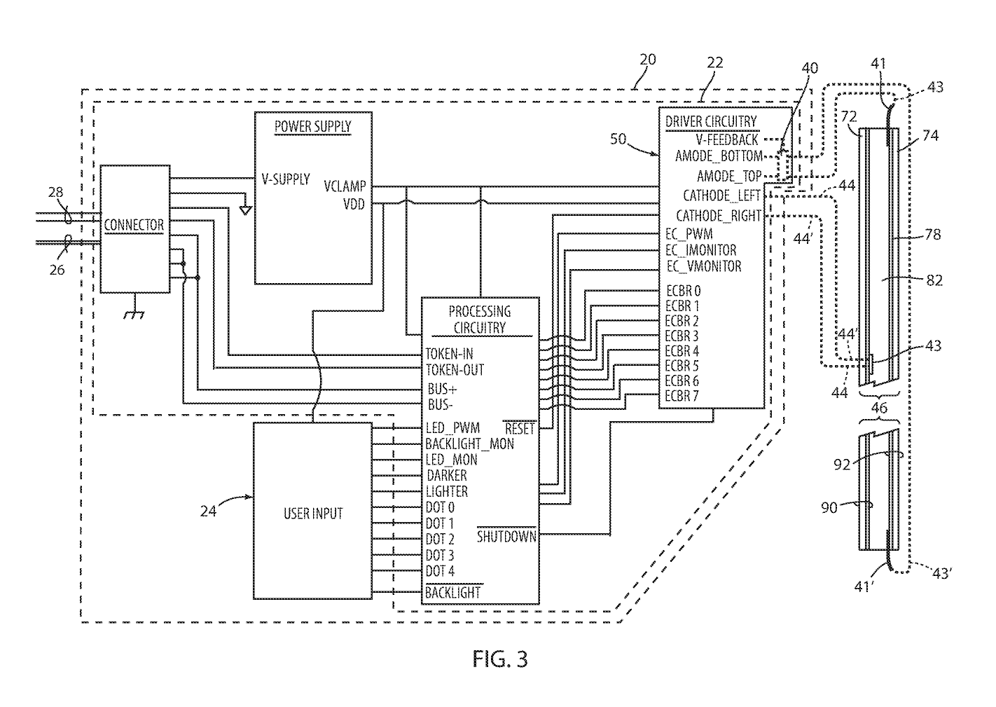

Referring now to FIGS. 2 and 3, in some embodiments, the window control system 18 may comprise local control circuitry 22. The local control circuitry 22 may comprise at least one feedback circuit 40. The feedback circuit 40 may be configured to detect a voltage output potential supplied or supplied voltage to a plurality of electrochromic supplies 42 and 44 or electro-optic supplies. For example, the feedback circuit 40 may be configured to identify a flow of current supplied to the electrochromic supplies 42 and 44 or conductive supplies such that the local control circuit is operable to measure supplied voltage. In response to the output potential or supplied voltage detected or measured, the feedback circuit 40 may output a feedback signal. Based on a feedback signal from the feedback circuit 40, the local control circuitry 22 may adjust the output potential or output voltage to the electrochromic supplies 42 and 44 to ensure that an electrochromic element 46 or an electro-optic element of the variable transmittance window 10 is receiving a desired or optimum voltage level. The local control circuitry 22 may determine the optimum voltage based on a predetermined voltage level indicated in a memory or otherwise programmed into one or more circuits or logic devices incorporated in the local control circuitry 22.

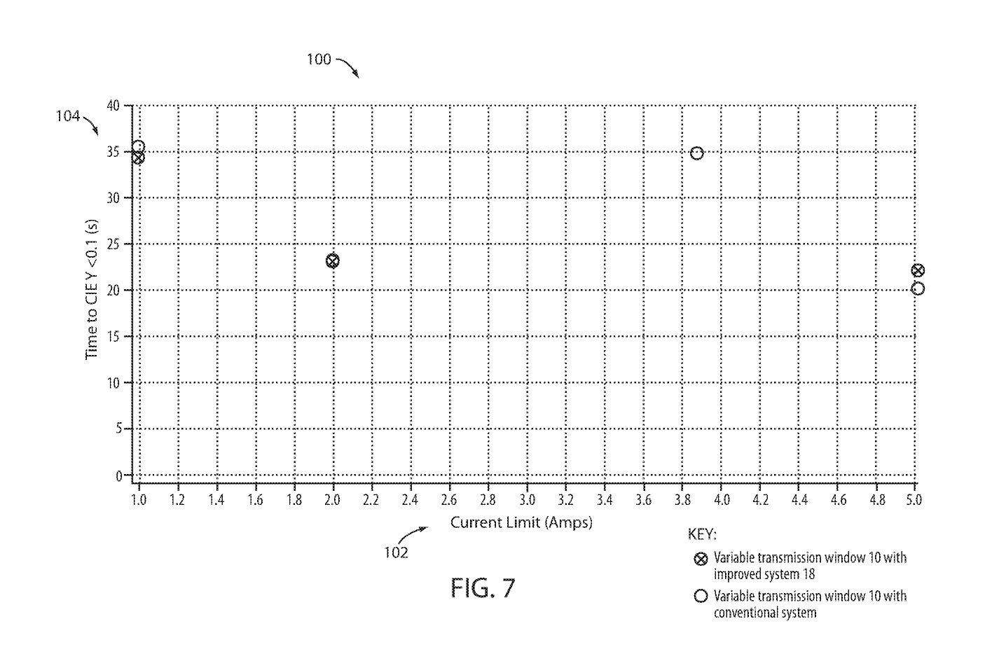

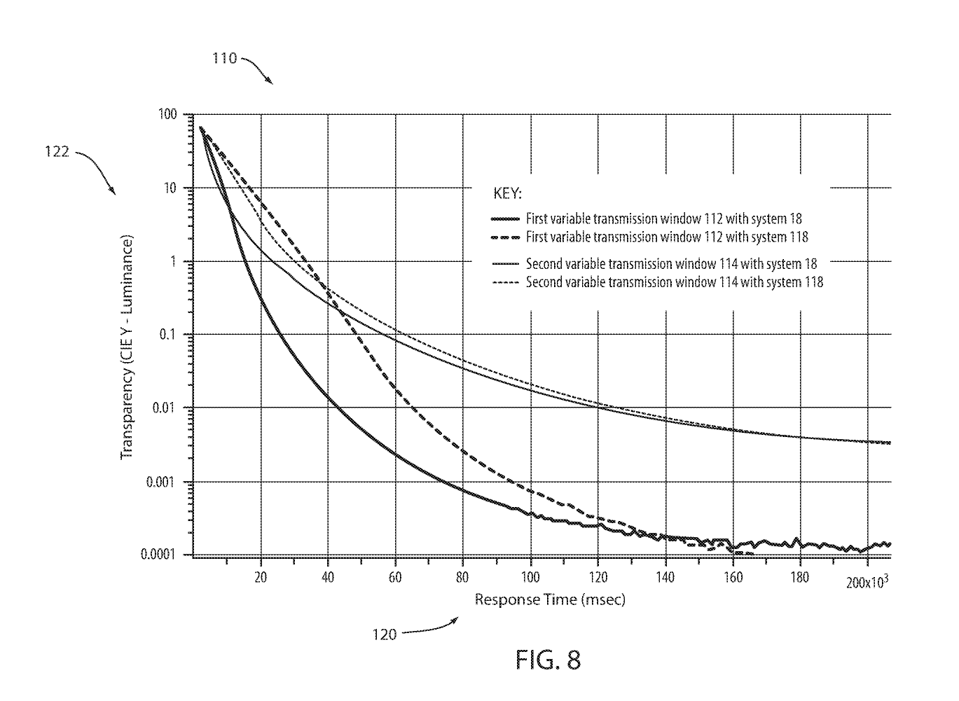

By monitoring and adjusting the voltage supplied to the electrochromic element 46, the control system 18 may provide for improved performance in the form of reduced transmittance adjustment time for the electrochromic elements 46. For example, by monitoring the voltage potential delivered the electrochromic element 46 or the electrochromic supplies 42 and 44, the local control circuitry 22 may be configured to detect a difference between a delivered voltage or supplied voltage and a desired voltage or optimum voltage. Based on the difference, local controller may adjust the current supplied to electrochromic supplies 42 and 44 to ensure the supplied voltage is approximately the same as the desired voltage. By utilizing such a method, the control system 18 has been shown to improve a transmittance adjustment time of the variable transmittance windows 10 by up to 50%. For detailed results demonstrating the performance improvements provided by the local control circuitry 22 utilizing the feedback circuit 40, refer to FIGS. 7 and 8.

The local control circuitry 22 may comprise and/or be in communication with the feedback circuit 40. In some embodiments, the feedback circuit 40 may be incorporated in the local control circuitry 22. In various embodiments, the feedback circuit 40 may be in communication with the local control circuitry 22 via a remote sensing line 48. The remote sensing line 48 may be coupled to a driver circuitry 50 of the local control circuitry 22. In embodiments wherein the feedback circuit 40 is remote from the local control circuitry 22 and in communication via the remote sensing line 48, the feedback circuit 40 may be disposed proximate a distal end portion 48b of the remote sensing line 48 and coupled to the feedback circuit 40 proximate an end portion 48a. The remote sensing line 48 may comprise one or more conductors in communication with the electrochromic supplies 42 and/or 44 via one or more sensing devices, which may form a portion of the feedback circuit 40.

The feedback circuit 40 may be located proximate the electrochromic element 46 or the electro-optic element and in some embodiments, may be coupled to one or more of the conducting lines or structures 41, 43, and 48. The feedback circuit 40 may be in communication with the local control circuitry 22 via a feedback input V_FEEDBACK, which may monitor the voltage supplied to the electrochromic supplies 42, 44 and/or the voltage detected by the remote sensing line 48. In this configuration, the local control circuitry 22 may monitor the potential voltage delivered to the electrochromic supplies and/or electrochromic element 46 with the feedback input V_FEEDBACK. In response to identifying the potential voltage supplied to the electrochromic elements 46 and/or the electrochromic supplies 42, 44, the local control circuitry 22 may adjust the voltage or current delivered to the electrochromic element 46.

For example, the controller circuitry 22 may monitor the feedback input V_FEEDBACK via an analog to digital converter (ADC) during a transmittance adjustment cycle to determine the voltage potential delivered to the electrochromic elements 46 and/or the electrochromic supplies 42, 44. In response to identifying that the delivered voltage is less than the desired or optimum voltage, the local control circuitry 22 may increase the current supplied to the electrochromic element 46 by increasing the output voltage and potential supplied to the electrochromic supplies 42 and 44. In this way, the control circuitry 22 may maintain the desired voltage at the electrochromic element 46 to provide for the improved rate of change of transmittance of the variable transmittance windows 10.

The difference in the delivered voltage in comparison to the desired voltage may be a result of the combined resistances or losses associated with the window control system 18. For example, the difference in the supplied voltage in comparison to the desired voltage may be the result of losses in the driver circuitry 50, component wear, system operating temperatures, losses in the electrochromic supplies 42 and 44 and/or losses in one more communication busses that may be incorporated to communicatively couple the local control circuitry 22 to the electrochromic element 46. Accordingly, the disclosure may provide for improved performance of the electrochromic element 46 in various systems for variable transmittance windows 10. Additionally the feedback circuit 40 and associated operation may be incorporated in control systems for variable transmittance windows 10 without introducing additional cost and weight that may be incurred by utilizing wires and/or components with lower resistance and associated losses.

Referring now to FIG. 3, in some embodiments, the feedback circuit 40 may comprise a sensing resistor R_{SNS}. In such an embodiment, the distal end portion 48a of the remote sensing line 48 may be connected to the remote sensing resistor R_{SNS}. In this configuration, the driver circuitry 50 may detect the voltage received by the feedback input V_FEEDBACK over the known resistance of the resistor R_{SNS} to determine the voltage delivered to the electrochromic element 46. By comparing the voltage delivered to the desired voltage or a reference voltage, the local control circuitry 22 may detect a difference in the supplied or delivered voltage relative to an optimum voltage level. In response to a drop in the delivered voltage, the local control circuitry 22 may increase the potential output to the electrochromic element 46. In this way the rate of change of the transmittance of the electrochromic element 46 may be optimized. Further detailed discussion of circuits and systems similar to the window control system 18 is provide in commonly owned U.S. Pat. No. 8,547,624 B2, the disclosure of which is incorporated herein by reference in its entirety.

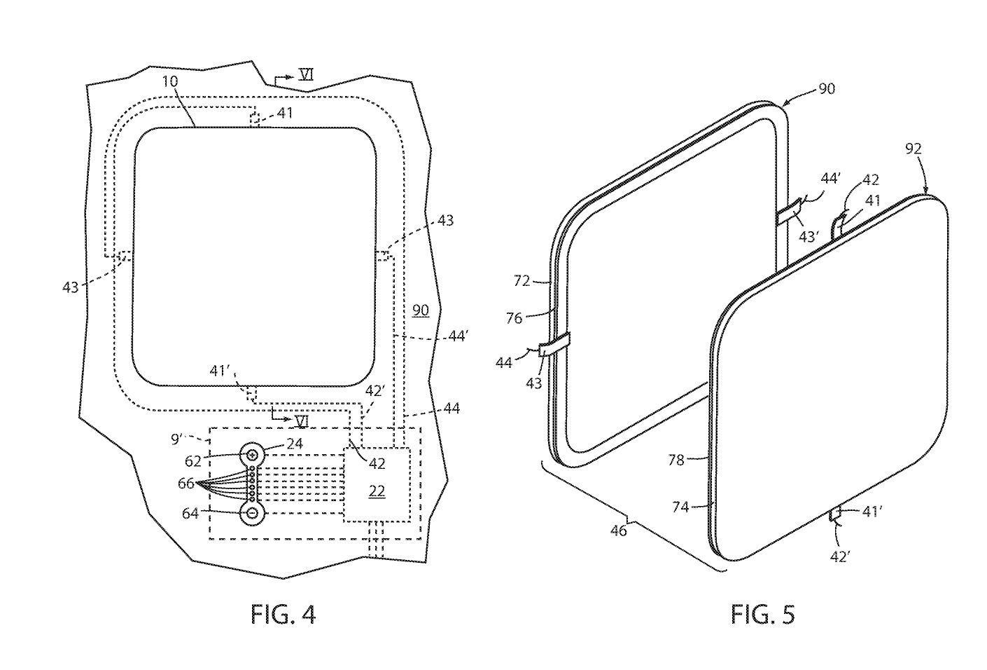

Referring now to FIGS. 4, 5, and 6, the variable transmittance window 10 and window control unit 20 are shown. Window control unit 20 includes the user input mechanism 24, including first user input area 62, second user input area 64, and indicator lights 66. Also shown in hidden lines are local control circuitry 22 and electrochromic supplies 42, 42′, 44, and 44′ coupled to conducting structures 41, 41′, 43, and 43′, respectively, of variable transmittance window 10. As shown, user input mechanism 24 has first user input area 62 and second user input area 64 configured to be physically contacted by a user of variable transmittance window 10 to change a selected transmittance state of the variable transmittance window 10. Indicator lights 66 are configured to display light indicating the current transmittance state of the window, the selected transmittance state of the window, whether the window is currently changing states, and/or whether the window control system is in an error state. As shown, user input mechanism 24 may be made of a material that is impervious to moisture, and may be sealed to keep moisture and dirt from internal electrical and mechanical structures of user input mechanism 24 and local control circuitry 22.

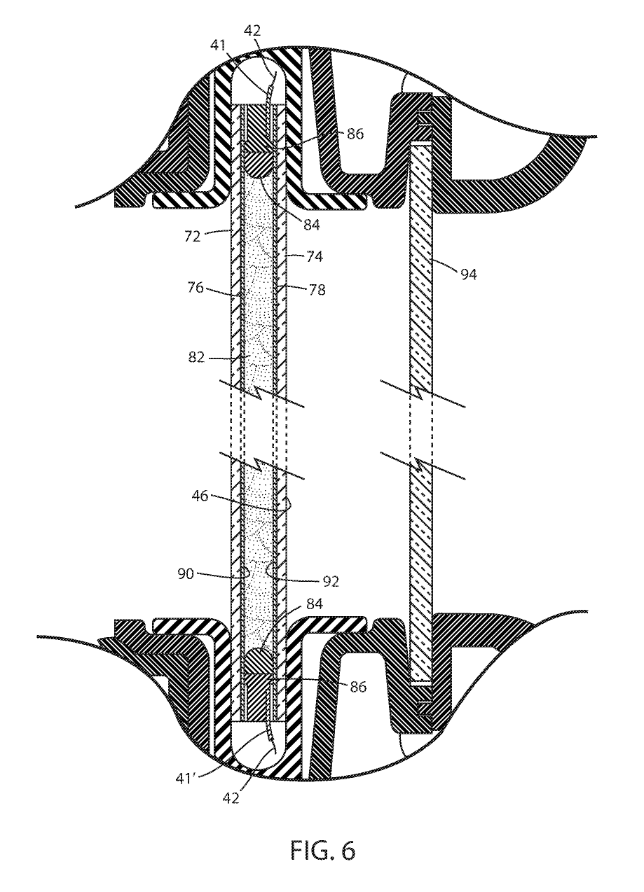

FIG. 6 is a cross-section of a variable transmittance window 10 and elements of a window control system 18. Variable transmittance window 10 includes an electrochromic element 46 or electro-optic element that includes a first substrate 72 and a second substrate 74 protected by a dust cover 94. In the present embodiments, substrates 72 and 74 are thin glass substrates. In alternate embodiments, substrates 72 and 74 are clear substrates of varying thicknesses that may be made of glass or other suitable substrate materials. Each substrate 72 and 74 may comprise a transparent highly electrically conductive layer 76 and 78, respectively, deposited thereon. In a preferred embodiment, first and second substrates 72 and 74 are made of glass and preferably have a thickness of less than about 1.2 mm, more preferably of less than about 0.8 mm, and most preferably of less than about 0.6 mm. In an alternate embodiment, the substrates may be bent. In the present embodiment, transparent highly electrically conductive layers 76 and 78 comprise indium-tin oxide (ITO) preferably at a thickness of at least two, full waves.

As shown, the space between first substrate 72 and second substrate 74 is filled with an electrochromic medium 82 in electrical contact with layers 76 and 78. The electrochromic medium 82 is deposited between the first substrate 72 and second substrate 74 through a fill hole (not shown) in one of the first substrate 72 and second substrate 74. The electrochromic medium 82 is retained between the inner surfaces of first substrate 72 and second substrate 74 by a first seal 84 and a second seal 86. First and second seals 84 and 86 also serve to maintain the space between the surfaces of first substrate 72 and second substrate 74. First seal 84 or second seal 86 may comprise a material that substantially holds its size and shape. In this case the first or second seal material may be used to establish the spacing between the substrates.

The surface of each of first substrate 72 and second substrate 74 that has been coated with transparent conductive layer 76 or 78 also includes a highly conductive material deposited on the transparent conductive layer 76 around a significant portion of the perimeter of each of first substrate 72 and second substrate 74. In the present embodiment, the highly conductive material is silver epoxy comprising silver flakes. Each of first substrate 72 and second substrate 74 also includes multiple conducting structures 41, 41′, 43, and 43′ electrically coupled to the highly conductive material deposited around a significant portion of the perimeter of the structures. The conducting structures 43 and 43′ of first substrate 72 are electrically coupled to electrochromic supplies 45 and 45′, respectively, via conducting material. The conducting structures 41 and 41′ of second substrate 74 are each coupled to electrochromic supplies 43 and 43′, respectively, via conducting material. In this manner, power provided by driver circuitry 50 is provided to the transparent electrically conductive layers 76 and 78 of each of first substrate 72 and second substrate 74, respectively. If a silver epoxy is used, the conducting structures 41, 41′, 43, and 43′ are preferably silver tabs and the conducting material would preferably contain silver flake.

It should be appreciated that additional coatings can be selected to minimize the optical impact of these additional layers. For example, opaque, highly absorbing or high refractive index coatings, which dramatically affect the optics of the final electrochromic element 46, should be avoided. The preferred stress compensation coating layer would have a low refractive index similar to that of the substrate 72. Layers with higher refractive indices may be used in certain applications.

Referring now to FIG. 7, a graph 100 of a supplied current limit 102 in Amps versus a transition time 104 in seconds is shown for a variable transmittance window control system with a sense electrode. For comparison, results are also shown for a variable transmittance window control system 18 without a sense electrode. The transition time 104 may correspond to the time required to change the transmittance of a window from a substantially transparent level to a CIE Y (Luminance) value of less than 0.1. Analysis of the results demonstrates that by including a sensing electrode or the feedback circuit 40, as previously discussed, the transition time for the window control system to transition from the a substantially transparent level to a CIE Y (Luminance) value of less than 0.1 may be reduced. Accordingly, the incorporation of the sensing electrode (e.g. the feedback circuit 40) may provide for improved performance of the window control systems discussed herein.

As illustrated by the test results, at lower current limits (e.g. 1 Amp), the incorporation of the sensing electrode increased the transition time 104 from approximately 34.5 sec. to 35.5 sec. At a current limit of 2 Amps, the incorporation of the sensing electrode had little effect on the transition time. However, the transition time 104 corresponding to the current limit of 5 Amps improved the transition time from approximately 22.2 sec. to 20.1 sec. Accordingly, by monitoring the current via the sensing electrode (e.g. the feedback circuit 40), the local control circuitry 22 of the control system 18 may be operable to ensure that the current is consistently supplied to the electrochromic element 46 such that the transition time 104 is improved. Accordingly, the control system 18 may provide for improved performance in the form of faster transitions by utilizing the sensing electrode (e.g. the feedback circuit 40) to ensure that a desired current is supplied to the electrochromic element 46.

Referring now to FIG. 8, a graph 110 performance characteristics for the window control system 18 for two different exemplary variable transmittance windows 10 are shown to compare the performance improvements provided by the feedback circuit 40. As demonstrated, the performance characteristics of a first variable transmittance window 112 are shown compared to the performance characteristics for a second variable transmittance window 114. Additionally, the performance characteristics for each of the variable transmittance windows 112, 114 are shown for a conventional window control system 118 and the improved window control system 18 comprising the feedback circuit 40. From the results, the improved performance provided by the improved window control system 18 discussed herein are apparent.

The graph 110 demonstrates the response time 120 of each of the variable transmittance windows 112, 114 to adjust a level of transparency 122 (e.g. CIE Y luminance) based on the voltage potential supplied by the conventional window control system 118 and the improved window control system 18. As illustrated, the transparency 122 of each of the variable transmittance windows 112 and 114 changes at an increased rate in response to the improved window control system 18 compared to the conventional window control system 118. The improved or increased rate of change in the transparency 122 and corresponding change in transmission through the variable transmittance windows 112, 114 may be improved as a result of the improved window control system 18 increasing the voltage potential supplied to the electrochromic supplies 42 and 44 in response to an indication from the feedback circuit 40 that the voltage potential supplied is less than a desired or optimum voltage level.

The results of FIG. 8 demonstrate that the improved window control system 18 is operable to improve the response of the transparency control of the variable transmittance windows 112, 114 particularly during the first half of a total transmission change period. For example, the second variable transmission window 114 reaches a substantially lower level of transparency 122 over the first 30 seconds of transition in response to the control provided by the improved window control system 18 than in response to the conventional window control system 118. The response time 120 over the initial stages of change in the transparency 122 may provide for a large improvement of the apparent response time particularly as shown on the logarithmic scale of FIG. 8. Accordingly, the improved window control system 18 may provide for improved performance for a variety of applications.

Although the above description of the preferred embodiments are primarily directed to window control systems for aircraft, it should be appreciated that the preferred embodiments, including those utilizing master and slave controller circuitry and algorithms, can be utilized to control the transmittance of windows in buildings and in other vehicles designed to carry passengers, such as, for example, ships, buses, and automobiles.

The above description is considered that of the preferred embodiments only. Modifications of the invention will occur to those skilled in the art and to those who make or use the invention. Therefore, it is understood that the embodiments shown in the drawings and described above are merely for illustrative purposes and are intended to be included within, but not intended to limit the scope of the invention, which is defined by the following claims as interpreted according to the principles of patent law, including the doctrine of equivalents.

What is claimed is:

1. A control system for variable transmittance windows, comprising:
at least one electro-optic element;
a local control circuit in communication with the electro-optic element via a conductive supply, wherein the local control circuit is configured to control an output voltage;
a feedback circuit in communication with the conductive supply and configured to measure a supplied voltage received at the conductive supply, and communicate a feedback signal to the local control circuit;
wherein the local control circuit is configured to:
receive the feedback signal;
identify the supplied voltage based on the feedback signal;
compare the supplied voltage to an optimum voltage level; and
adjust the output voltage in response to the comparison.

2. The system according to claim 1, wherein the supplied voltage is the voltage transmitted to the conductive supply comprising one or more losses attributed to circuitry of the local control circuit.

3. The system according to claim 1, wherein the local controller is further configured to:
based on the comparison of the supplied voltage to optimum voltage level, adjust the output voltage to limit a difference between the supplied voltage and the optimum voltage level.

4. The system according to claim 3, wherein the local controller is configured to increase the output voltage potential output to electro-optic element to optimize a rate of change of transmittance of the electro-optic element.

5. The system according to claim 1, wherein the at least one electro-optic element corresponds to a plurality of electro-optic elements each comprising a local control circuit.

6. The system according to claim 5, further comprising:
a master control circuit in communication with the plurality of local control circuits, wherein the master control circuit is configured to communicate a master control input thereby controlling the transmission level of each of the local control circuits.

7. The system according to claim 6, wherein each of the local control circuits comprises a user interface configured to receive a local input to control the transmission level of the electro-optic element.

8. The system according to claim 7, wherein the local control circuit is configured to prioritize the master control input over the local input to control of the transmission level.

9. The system according to claim 1, wherein the electro-optic element is an electrochromic element.

10. A method for controlling a transmission level of a variable transmission window, the method comprising:
measuring a supplied voltage at a conductive supply of the variable transmission window;
communicating the supplied voltage to a controller as a feedback signal;
receiving the feedback signal at the controller;
identifying the supplied voltage at the conductive supply based on the feedback signal;
comparing the supplied voltage to an optimum voltage level; and
adjusting an output voltage in response to the comparison, wherein the output voltage is adjusted thereby correcting for a loss in the supplied voltage at the conductive supply.

11. The method according to claim 10, wherein the optimum voltage corresponds to a voltage intended to be supplied to the conductive supply thereby maximizing a rate of change of a transmission level of the variable transmission window.

12. The method according to claim 10, wherein the adjusting of the output voltage comprises limiting a difference between the supplied voltage and the optimum voltage level.

13. The method according to claim 10, wherein the measuring the supplied voltage identifies a voltage loss due to drive circuitry in the controller.

14. A control system for variable transmittance windows, comprising:
at least one electro-optic element;
a local control circuit in communication with the electro-optic element via a conductive supply; and
a feedback circuit in communication with the conductive supply and configured to communicate a feedback signal to the local controller, wherein the local control circuit is configured to:
receive the feedback signal; and
adjust an output voltage transmitted to the conductive supply in response to the feedback signal.

15. The system according to claim 14, wherein the feedback circuit is configured to measure a supplied voltage at the conductive supply.

16. The system according to claim 15, wherein the local controller is further configured to:
identify the supplied voltage based on the feedback signal.

17. The system according to claim 16, wherein the local controller is further configured to:
compare the supplied voltage to an optimum voltage level to be supplied to the conductive supply.

18. The system according to claim 17, wherein the local controller is further configured to:
based on the comparison of the supplied voltage to optimum voltage level, adjust the output voltage to limit a difference between the supplied voltage to optimum voltage level.

19. The system according to claim 14, wherein the local controller further comprises a driver circuit in communication with conductive supply and configured to transmit the control voltage to the electro-optic element.

20. The system according to claim 14, wherein the electro-optic element is an electrochromic element.
